(19) United States
(12) Patent Application Publication
(10) Pub. No.: US 2013/0065643 A1
(43) Pub. Date: Mar. 14, 2013

(54) MOBILE TERMINAL HAVING MODE TRANSITION FUNCTION AND DRIVING METHOD THEREOF

(71) Applicant: Min A SONG, Seoul (KR)

(72) Inventor: Min A SONG, Seoul (KR)

(73) Assignee: PANTECH CO., LTD., Seoul (KR)

(21) Appl. No.: 13/607,081

(22) Filed: Sep. 7, 2012

(30) Foreign Application Priority Data
Sep. 9, 2011 (KR) 10-2011-0091702

(51) Int. Cl. H04W 88/02

(52) U.S. Cl. 455/557

(57) ABSTRACT

A mobile terminal includes a connecting part to connect to a device, a mode performing and shifting unit to identify a type of the device, to determine multiple modes according to the type of the device, and to shift to a first mode among the multiple modes in response to a mode shifting signal, and a switch to generate the mode shifting signal. A method for changing modes in association with a device includes connecting a device to a terminal, identifying a type of the device, determining multiple modes according to the type of the device, receiving a mode shifting signal during the connection of the device, and shifting from a first mode to a second mode in response to a mode shifting signal.

### CROSS-REFERENCE TO RELATED APPLICATION

This application claims priority from and the benefit under 35 U.S.C. §119 of Korean Patent Application No. 10-2011-0091702, filed on Sep. 9, 2011, which is hereby incorporated by reference for all purposes as if fully set forth herein.

### BACKGROUND

1. Field

The present disclosure relates to a mobile terminal having a mode transition function and a driving method for the same, and more particularly, to a mobile terminal and a method for managing operational modes of a peripheral device.

2. Discussion of the Background

A mobile terminal may have a connector or a receptacle to connect an external connection device or a peripheral device. For example, if a protection cover of a multi-port of a mobile terminal is removed, the multi-port may be exposed externally so that an external connection device may be inserted into the multi-port of the mobile terminal. A charging device, a USB cable, or an earphone jack may be inserted into the multi-port of an existing mobile terminal.

However, in an existing mobile terminal such as a tablet, a smart phone, a portable computer, and a cellular phone, working tasks and executed tasks may be arranged or terminated, for example by calling a user interface (UI) of a task manager and manipulating the UI to reduce or minimize power consumption while a charger, a USB cable, or an earphone jack is connected to the mobile terminal.

For example, if a USB cable is connected, UI manipulation may be performed to change modes between a Universal Serial Bus (USB) mass storage (UMS) mode or a synchronization mode. If the USB cable is connected to the mobile terminal, the UI may be called. Further, during the usage of the mobile terminal, to change the mode to a sleep mode to dedicate battery consumption to the connected device, the UI may be called again. Specifically, in order to change the UMS/synchronization mode again while tasks are being executed in the background, the UI may be called repeatedly. In addition, during this process, the tasks at work may be terminated without providing a restoration procedure.

### SUMMARY

Exemplary embodiments of the present invention provide a mobile terminal having a mode transition function for a peripheral device, and a method for managing operational modes of the peripheral device.

Additional features of the invention will be set forth in the description which follows, and in part will be apparent from the description, or may be learned by practice of the invention.

An exemplary embodiment of the present invention provides a mobile terminal, including a connecting part to connect to a device; a mode performing and shifting unit to identify a type of the device, to determine multiple modes according to the type of the device, and to shift to a first mode among the multiple modes in response to a mode shifting signal; and a switch to generate the mode shifting signal.

An exemplary embodiment of the present invention provides a mobile terminal, including a connecting part to connect to a device; a mode performing and shifting unit to determine multiple modes according to a type of the device, and to change from a default mode to a shifted mode in response to a mode shifting signal; a switch to generate the mode shifting signal; and a restoring unit to back-up one or more tasks to change to the shifted mode in response to the mode shifting signal, and to terminate the one or more tasks based on the type of the device.

An exemplary embodiment of the present invention provides a method for changing modes in association with a device, including connecting a device to a terminal; identifying a type of the device; determining a default mode and a shifted mode according to the type of the device; receiving a mode shifting signal during the connection of the device; and shifting from the default mode to the shifted mode in response to a mode shifting signal.

It is to be understood that both forgoing general descriptions and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a cross-sectional view showing a mobile terminal having a mode shifting function according to an exemplary embodiment of the present invention.

FIG. 2 is a cross-sectional view showing a mobile terminal having a mode shifting function according to an exemplary embodiment of the present invention.

FIG. 3 is a cross-sectional view showing a mobile terminal having a mode shifting function according to an exemplary embodiment of the present invention.

FIG. 4 shows a configuration of a mobile terminal having a mode shifting function according to an exemplary embodiment of the present invention.

FIG. 5 is a flowchart illustrating a method for performing a mode shifting function according to an exemplary embodiment of the present invention.

FIG. 6 is a diagram showing a method for performing a back-up procedure of task control blocks and restoring the task control blocks according to an embodiment of the present invention.

### DETAILED DESCRIPTION OF THE ILLUSTRATED EMBODIMENTS

Exemplary embodiments now will be described more fully hereinafter with reference to the accompanying drawings, in which exemplary embodiments are shown. The present disclosure may, however, be embodied in many different forms and should not be construed as limited to the exemplary embodiments set forth therein. Rather, these exemplary embodiments are provided so that the present disclosure will be thorough and complete, and will fully convey the scope of the present disclosure to those skilled in the art. In the description, details of well-known features and techniques may be omitted to avoid unnecessarily obscuring the presented embodiments.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. It will be understood that for the purposes of this disclosure, “at least one of” will be interpreted to mean any combination the enumerated elements following the respective language, including combination of multiples of the enumerated elements. For example, “at least one of X, Y, and Z” will be construed to mean X only, Y only, Z only, or any combination of two or more items X, Y, and Z (e.g. XYZ, XZ, XZZ, YZ, X).

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

In the drawings, like reference numerals denote like elements. The shape, size and regions, and the like, of the drawing may be exaggerated for clarity.

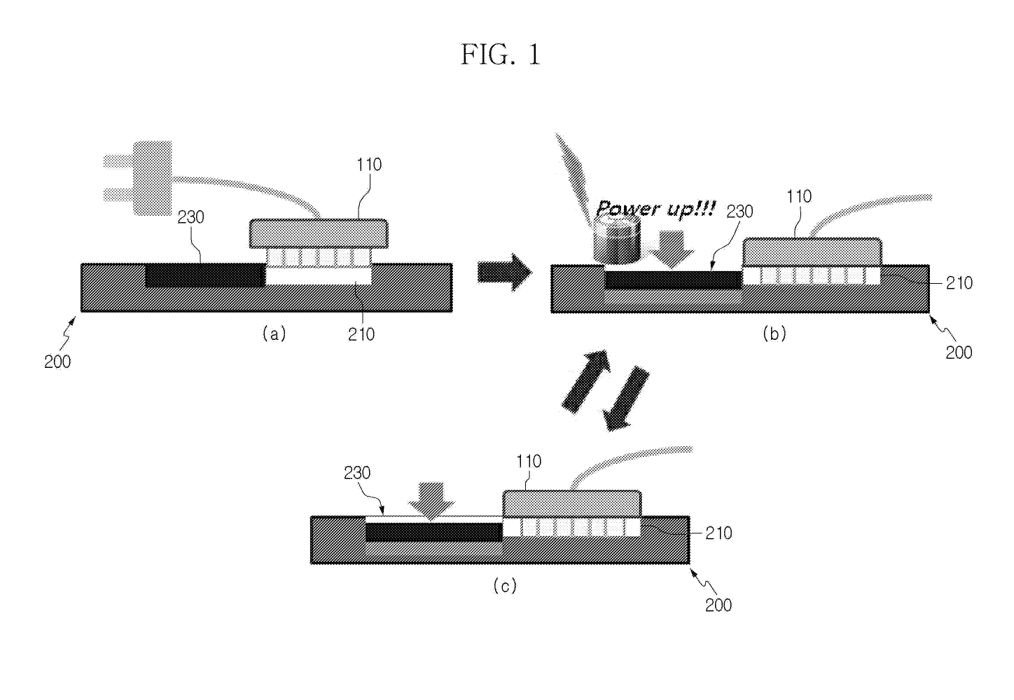

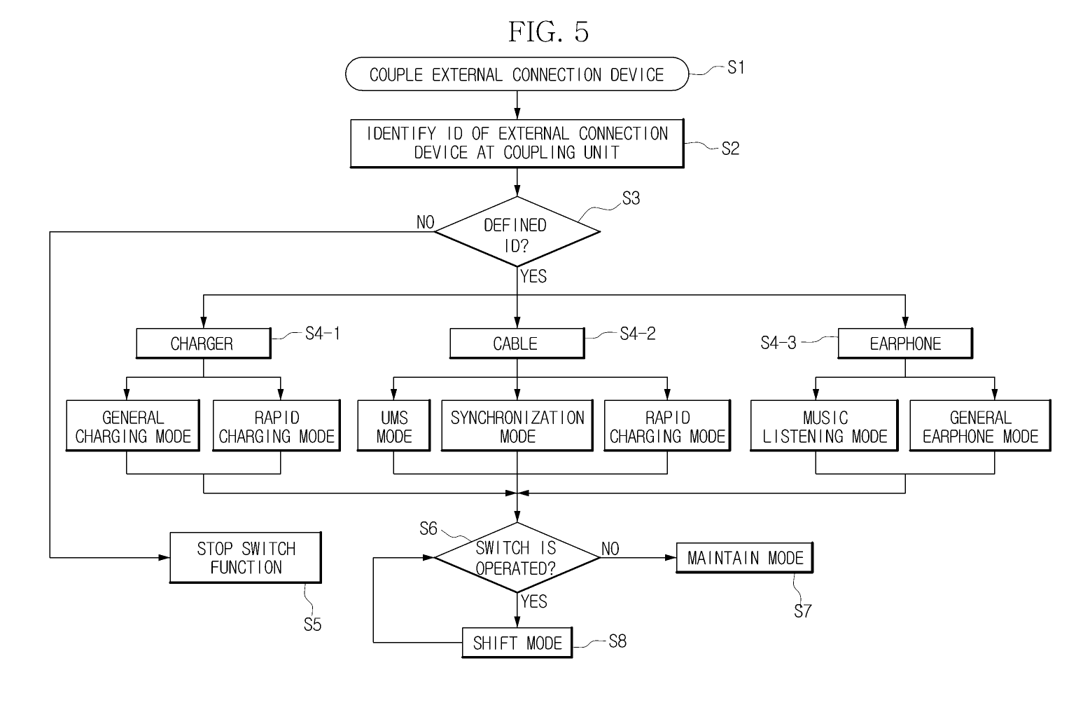

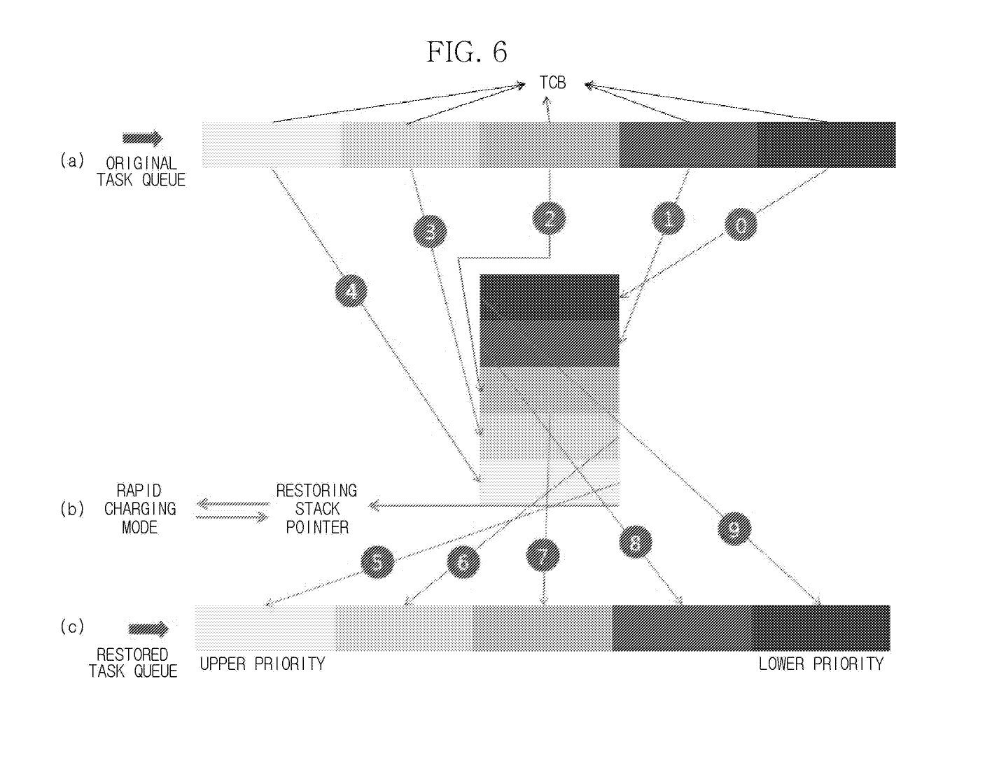

FIG. 1 is a cross-sectional view showing a mobile terminal having a mode shifting function according to an exemplary embodiment of the present invention. FIG. 1 illustrates a process of changing modes between a rapid charging mode and a general charging mode using a mode changing button. The mode changing button (hereinafter, referred to as “switch 230”) may be pressed in a state where a charger 110 is connected with a coupling unit 210 while the coupling unit 210 of a mobile terminal 200 is exposed to outside. The coupling unit 210 may be a type of a connector or a connecting part that may accommodate and connect to an external or detachable device. While the charger 110 is coupled to the coupling unit 210 of the mobile terminal 200, a normal charging mode or a rapid charging mode may be maintained before the switch 230 is pressed. For example, as shown in FIG. 1, the normal charging mode may be the default setting (see (a) of FIG. 1). If the switch 230 is pressed, the normal charging mode may be changed into the rapid charging mode (see (b) of FIG. 1). In the rapid charging mode, one or more executed tasks may be backed-up and be terminated to reduce or minimize battery power consumption during the charging process to accelerate a charging speed. During the rapid charging mode, minimum call-waiting function and charging function may be maintained. The backing-up and terminating processes of tasks will be described in more detail below with reference to FIG. 5 and FIG. 6. If the switch 230 is pressed again, the rapid charging mode may be changed back into the normal charging mode (see (c) of FIG. 1). In the normal charging mode, the tasks backed-up during the rapid charging mode may be restored.

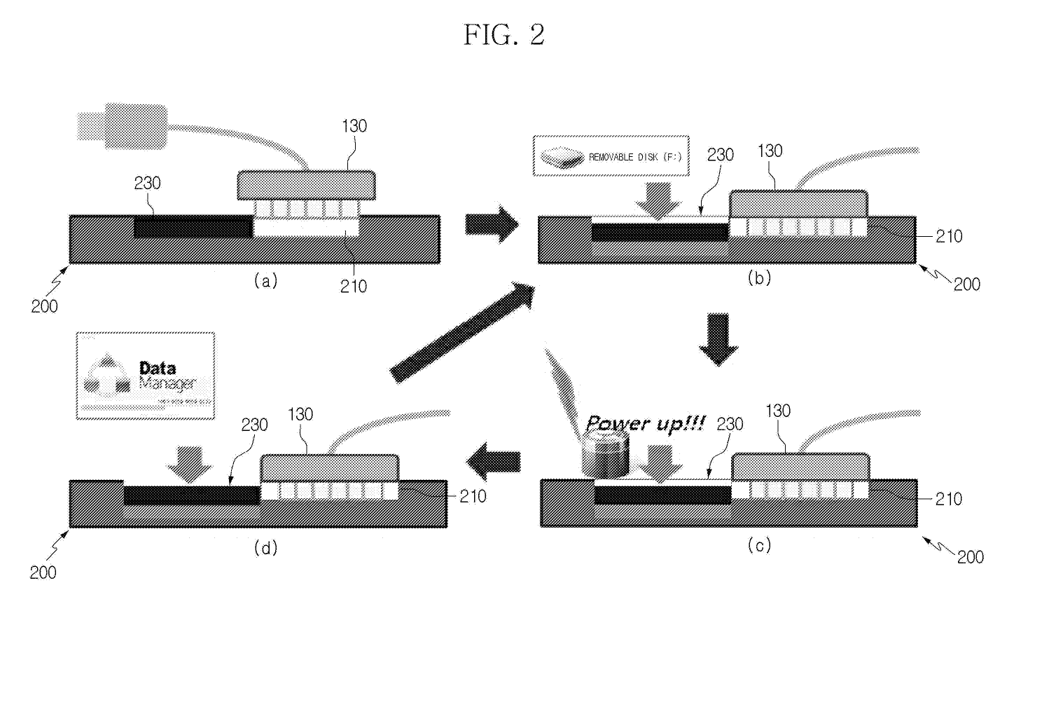

FIG. 2 is a cross-sectional view showing a mobile terminal having a mode shifting function according to an exemplary embodiment of the present invention. FIG. 2 illustrates a process of changing modes among a USB mass storage (UMS) mode, a synchronization (Sync) mode, and a rapid charging mode. If the switch 230 is pressed in a state where a USB cable 130 is connected with the coupling unit 210 of the mobile terminal 200, one of the USB mass storage (UMS) mode, the synchronization (Sync) mode, and the rapid charging mode may be determined. As shown in FIG. 2, a default setting may be the synchronization mode before the switch 230 is initially pressed (see (a) of FIG. 2), but is not limited thereto. The default setting may be the rapid charging mode or the UMS mode. In the synchronization mode, data exchange may be performed using a PC manager, a device managing program, and functions of a modem and a diagnosis port may be enabled. If the switch 230 is pressed, the mode may be changed into the UMS mode (see (b) of FIG. 2). In the UMS mode, the mobile terminal may be operated as a removable mass storage device and the function of a removable disk may be performed as a UMS. Specifically, the UMS mode may be different from the synchronization mode since the mobile terminal may not be recognized as a cellular phone but be recognized as a removable mass storage having a separate partition in the UMS mode, and the UMS mode may be operated without having a dedicated driver. If the switch 230 is pressed one more time, the mode may be changed into the rapid charging mode (see (c) of FIG. 2). In the rapid charging mode, one or more executed tasks may be backed up and be terminated while maintaining a task associated with USB operation and a minimum call-waiting function for the mobile terminal 200. If the switch 230 is pressed again, the backed-up tasks may be restored and the rapid charging mode may be changed to the synchronization mode (see (d) of FIG. 2). The sequence of mode changes may be modified, for example, from the synchronization mode to the rapid charging mode and from the rapid charging mode to the UMS mode. As described above, if the USB cable 130 is connected to the coupling unit 210, the three modes, the synchronization mode, the UMS mode and the rapid charging mode may be provided, but is not limited as such. Two modes or more than three modes may be provided in response to the USB cable 130 connection. The backing-up, terminating, and restoring of the tasks will be described in more detail below with reference to FIG. 5 and FIG. 6.

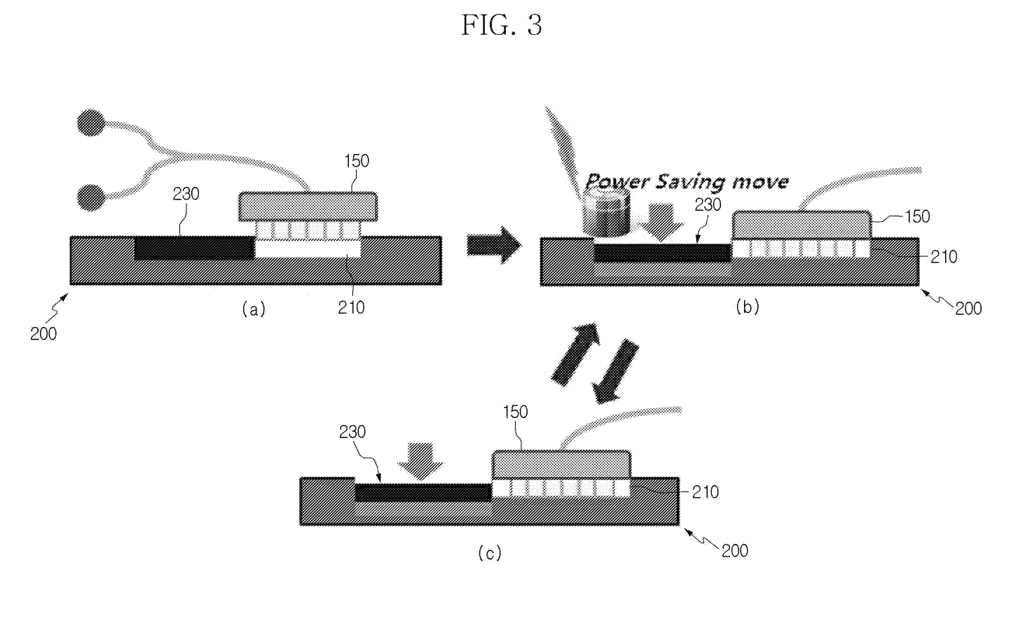

FIG. 3 is a cross-sectional view showing a mobile terminal having a mode shifting function according to an exemplary embodiment of the present invention. FIG. 3 illustrates a process of changing modes among a music listening mode and a normal earphone mode. If the switch 230 is pressed in a state where an earphone 150 is connected with the coupling unit 210 of the mobile terminal 200, one of multiple modes may be selected. If the earphone 150 is connected with the coupling unit 210, the normal earphone mode may be operated as a default setting while maintaining executions of current tasks (see (a) of FIG. 3), but is not limited thereto. The music listening mode may be set as the default setting. Further, if the switch 230 is pressed one time, one or more tasks may be backed up and be terminated while a task associated with music playback and a minimum call-waiting function is maintained for the mobile terminal 200, thereby power consumption may be reduced while media content is being played-back. If the switch 230 is pressed again, the backed-up tasks may be restored so that functions other than the music playback may be performed. The backing-up, terminating, and restoring of the tasks will be described in more detail below with reference to FIG. 5 and FIG. 6.

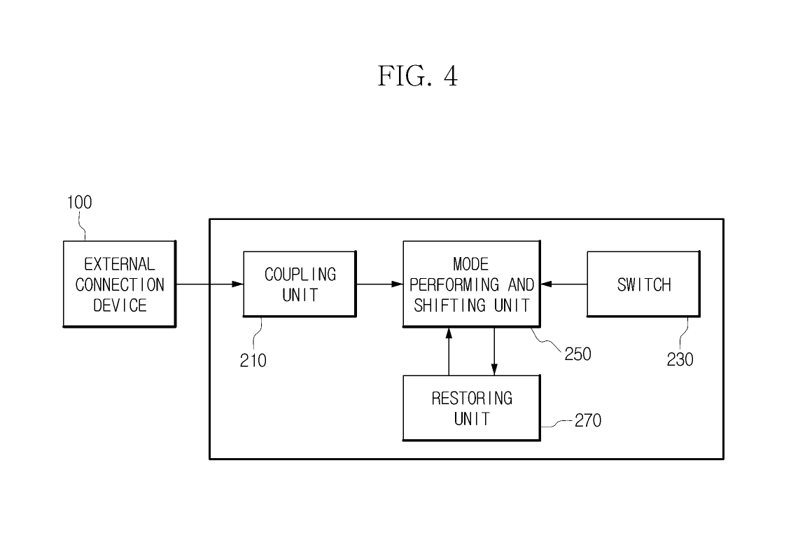

FIG. 4 shows a configuration of a mobile terminal having a mode shifting function according to an exemplary embodiment of the present invention. Referring to FIG. 4, the mobile terminal having a mode shifting function includes a coupling unit 210, a switch 230, a mode performing and shifting unit 250, and a restoring unit 270. Further, the coupling unit 210 may be coupled to an external connection device 100, such as a charger, a USB cable, and an earphone, and recognize the type of the external connection device 100. The external connection device 100 may be referred to as a detachable device or a detachable peripheral device. The type of the external connection device 100 may be determined based on device identification information of the external connection device 100. The mode performing and shifting unit 250 may be connected to the switch 230 and the coupling unit 210, perform operations in one of the modes according to the type of the external connection device 100, and change the modes if the mode shifting signal is received from the switch 230. Further, the mode performing and shifting unit 250 may determine the type of the external connection device 100 connected to the coupling unit 210 based on the device identification information of the external connection device 100 or a signal received from the external connection device 100. The switch 230 may generate the mode shifting signal if the switch 230 is pressed. The restoring unit 270 may be connected to the mode performing and shifting unit 250, and back up or restore one or more executed tasks according to the mode change. The restoring unit 270 may be used as a temporal storage for the back up or the restoring processes.

The coupling unit 210 may include a port groove, to which the external connection device 100 is connected, and a portion identifying device identification (ID) of the external connection device 100. The mode performing and shifting unit 250 may determine the type and number of available modes for the external connection device 100 according to the ID. The switch 230 may transmit a mode shifting signal to the mode performing and shifting unit 250. The switch 230 may be disposed adjacent to the coupling unit 210. Further, the switch 230 may have a form of a switch physically arranged on the mobile terminal 200, or may be a functional button, such as a touch sensor that may be touched by a user. Furthermore, the switch 230 may be a button-type that may be vertically movable, as shown in FIG. 1, FIG. 2, and FIG. 3 or a bar-type that is horizontally movable, for example, from the left to the right. The mode performing and shifting unit 250 may receive the mode shifting signal from the switch 230, and back up an executed task to the restoring unit 270 and terminate the executed task if a mode is changed. Further, the mode performing and shifting unit 250 may restore an executed task from the restoring unit 270 if a mode is changed. The procedures of the mode performing and shifting unit 250 may be performed according to the ID of the external connection device 100 recognized by the mode performing and shifting unit 250 through the coupling unit 210. Tasks may be backed up by the restoring unit 270 to a memory space of a stack structure, and the memory space may stores task control blocks (TCB) of the tasks, and a stack top of most recently backed-up task may be notified to the mode performing and shifting unit 250. To restore the task, the mode performing and shifting unit 250 may access the restoring unit 270 by using the stack top.

FIG. 5 is a flowchart illustrating a method for performing a mode shifting function according to an exemplary embodiment of the present invention. FIG. 5 will be described as if performed by mobile terminal shown in FIG. 4, but is not limited as such. Referring to FIG. 5, if the coupling unit 210 is externally exposed, an external connection device 100 may be coupled with the coupling unit 210 in operation S1. In operation S2, the coupling unit 210 may check the information (for example, ID) of the external connection device 100. In operation S3, the mode performing and shifting unit 250 may determine whether the ID of the external connection device 100 is a registered ID. If the external connection device 100 is not identifiable device or the ID is not a registered ID, mode changing operation may not be performed in operation S5, even though the switch is pressed. If the connected external connection device 100 is determined as an identifiable device in operation S3, the process may proceed to a corresponding mode according to the type of the external connection device 100 in operations S4-1, S4-2, and S4-3, respectively. The type of the external connection device 100 may be identified by the identification information of the external connection device 100.

If the external connection device 100 is determined to be a charger, a rapid charging mode or a normal charging mode may be provided and selected in operation S4-1. For example, the normal charging mode or the rapid charging mode may be selected as a default setting in response to the charger connection, and an input of the switch 230 may change the mode of the default setting to another mode. For example, if the default setting is the normal charging mode, a mode change from the normal charging mode to the rapid charging mode may be performed by user's operation of the switch 230 in operation S6. Then, the mode may be changed into another mode in operation S8. In the example, the default setting, the normal charging mode, may be changed to the rapid charging mode. The operation of changing mode to the rapid charging mode may include a process of backing up TCB of tasks in a memory or a storage space before terminating the corresponding tasks for the rapid charging mode. Further, the user may operate the switch 230 again in operation S6, so that the executed mode may be changed to another mode in operation S8. If the rapid charging mode is being changed into the normal charging mode, the process and/or the backed-up tasks may be restored to the state before initiating the rapid charging mode. The operation of changing mode to the normal charging mode may include a process of restoring the backed-up TCB so that the backed-up tasks may be restored to the state at the time of initiating the rapid charging mode. The mode change between the rapid charging mode and the normal charging mode may be determined according to the charging mode being executed. If two modes are available, the switch 230 may be operated as a toggle switch. Specifically, if the switch 230 is pressed, one mode may be toggled to the opposite mode. Further, if the switch 230 is not operated, it may be determined not to shift the executed mode in operation S6, and the executed mode may be maintained in operation S7. The terminating and restoring of TCB will be described in more detail with reference to FIG. 6.

If the external connection device 100 connected to the coupling unit 210 is a USB cable, the UMS mode, the synchronization mode and the rapid charging mode may be provided. If the USB cable is connected, the synchronization mode, the UMS mode, or the rapid charging mode may be provided as a default setting. For example, if the USB cable is connected with the coupling unit 210, the mobile terminal may display a selection screen whether the UMS mode is used (which means that the USB is used as a removable storage) or the PC synchronization mode is used. If a user selects one mode between the two modes, the executed mode may be changed into another mode. For example, if the synchronization mode is the default setting, the synchronization mode may be changed to the rapid charging mode or the UMS mode in operation S8, if the user operates the switch 230 in operation S6. Further, if the executed mode is changed to the rapid charging mode, TCB of tasks other than a task associated with the USB may be backed up and the backed-up tasks may be terminated. Thus, the rapid charging mode during the connection of the USB cable may be different from the rapid charging mode during the connection of the charger, since different TCBs associated with corresponding external connection device 100 may be preserved without termination according to the type of the external connection device 100. If the switch 230 is not pressed, it may be determined not to shift the executed mode in operation S6, and the executed mode may be maintained in operation S7.

If the external connection device 100 connected to the coupling unit 210 is an earphone, the music listening mode or the normal earphone mode may be provided. Further, the normal earphone mode, or the music listening mode may be a default setting. If a user operates the switch 230 in operation S6, the executed mode of the default setting may be changed to another mode in operation S8. The operation of shifting to the music listening mode may include a process of backing up TCB of tasks at work in a memory or a storage space before the corresponding tasks (tasks other than minimum tasks used for playing music) are terminated. Further, the user may operate the switch in operation S6, so that the executed mode may be shifted to another mode in operation S8. The operation of changing mode to the normal earphone mode may include a process of restoring the backed-up TCB so that the backed-up tasks may be restored to the state at the time of initiating the music listening mode. The mode change between the normal earphone mode and the music listening mode may be determined according to the mode being executed. The executed mode may be shifted to the opposite mode in response to an input of the switch 230 if two modes are provided for the external connection device 100. Further, if the switch 230 is not pressed, it may be determined not to shift the executed mode in operation S6. Then, the executed mode may be maintained in operation S7.

FIG. 6 is a diagram showing a method for performing a back-up procedure of task control blocks and restoring the task control blocks according to an embodiment of the present invention. Each task control block (TCB) may include the name of a task, a stack pointer, a waiting signal, a priority, and a link pointer to manage a TCB list. The link pointer may include a previous pointer and a next pointer, and TCB lists may be managed as a double linked list using the previous pointer and the next pointer. Each TCB may be allocated to one task. Further, to prepare a mode change to the rapid charging mode or the music listening mode, a copy of one TCB may be generated and pushed to a separate restoration stack which will be used for restoring the TCB, as shown in (b) of FIG. 6. After generating and pushing the TCB copy in the restoration stack, the original copy of TCB may be eliminated to terminate the task. The TCB may be closed from the task having the lowest priority in a task queue to the task having the highest priority in the task queue according to the scheduling policy of the operation system of the mobile terminal. For example, as shown in (a) of FIG. 6, in the original task queue, tasks are closed in the order of 0, 1, 2, 3 and 4. That is, tasks may be closed from the task having the lowest priority to the task having the highest priority. If TCBs are completely backed up and terminated, the mobile terminal may shift to the rapid charging mode (a power-saving mode) and maintain the restoring stack pointer for restoration of the TCBs. If the mobile terminal is restored to the normal charging mode (or, the USB mode, the synchronization mode or the normal earphone mode), the tasks may be restored in the task queue from the task having the highest priority to the task having the lowest priority. For example, as shown in (c) of FIG. 6, the tasks may be restored in the order of 5, 6, 7, 8 and 9 that is, tasks may be restored from the task having the highest priority to the task having the lowest priority. The TCB back-up and restoration procedure may be performed using a restoration stack of a “Last-In, First-Out” (LIFO) structure.

According to the present disclosure, in a mobile terminal to which an external connection device such as a charger, a USB cable and an earphone is connected, a mode for the external connection device may be shifted and backing up and restoring tasks may be performed according to the mode even though a user does not manually arrange and select the tasks to terminate one or more tasks by UI manipulation, for example. Further, the back-up and restoration procedures in association with the mode change may prevent the problem that contents of a task at work may be lost and not restored, and efficient power consumption management, mode change for the external connection device and task management may be possible when the external connection device is being used.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A mobile terminal, comprising:
a connecting part to connect to a device;
a mode performing and shifting unit to identify a type of the device, to determine multiple modes according to the type of the device, and to shift to a first mode among the multiple modes in response to a mode shifting signal; and
a switch to generate the mode shifting signal.

2. The mobile terminal of claim 1, further comprising a restoring unit to back-up a first task if the mode performing and shifting unit shifts to the first mode, and to terminate the first task.

3. The mobile terminal of claim 2, wherein the restoring unit prioritizes tasks, and stores information of the prioritized tasks from a lower-prioritized task to a higher-prioritized task.

4. The mobile terminal of claim 3, wherein the restoring unit restores the first task if the mode performing and shifting unit shifts to a second mode.

5. The mobile terminal of claim 4, wherein the first task is selected for back-up by the restoring unit before a second task, the second task having a higher priority than the first task.

6. The mobile terminal of claim 3, wherein the information of the prioritized tasks comprises information of a task control block.

7. The mobile terminal of claim 6, wherein the task control block comprises at least one of a task name, a stack pointer, a waiting signal, a priority, and a link pointer, and the link pointer is configured to manage a list of task control blocks.

8. The mobile terminal of claim 7, wherein the link pointer comprises a previous pointer and a next pointer to manage the list of task control blocks as a double linked list.

9. The mobile terminal of claim 1, wherein the switch is disposed adjacent to the connecting part.

10. The mobile terminal of claim 3, wherein the information of the prioritized is stored into a restoration stack.

11. The mobile terminal of claim 1, wherein the first mode comprises a normal charging mode or a rapid charging mode if the device is a charger,
the first mode comprises a storage mode, a synchronization mode, or a rapid charging mode if the device is a computer connector, and
the first mode comprises a normal earphone mode or a listening mode if the device is an earphone.

12. The mobile terminal of claim 1, wherein the type of the device is identified using device identification of the device.

13. The mobile terminal of claim 1, wherein the device comprises a charger, a universal serial bus cable connected to an external computing device, and an earphone.

14. The mobile terminal of claim 1, wherein the first mode is a mode in which one or more tasks are backed-up and terminated, and when the mode performing and shifting unit shifts to a second mode, the one or more tasks are restored using information of prioritized tasks,
wherein the one or more tasks are determined based on the type of the device.

15. The mobile terminal of claim 14, wherein a device control task for controlling the device is being executed in the first mode.

16. A mobile terminal, comprising:
a connecting part to connect to a device;
a mode performing and shifting unit to determine multiple modes according to a type of the device, and to change from a default mode to a shifted mode in response to a mode shifting signal;
a switch to generate the mode shifting signal; and
a restoring unit to back-up one or more tasks to change to the shifted mode in response to the mode shifting signal, and to terminate the one or more tasks based on the type of the device.

17. A method for changing modes in association with a device, comprising:
connecting a device to a terminal;
identifying a type of the device;
determining a default mode and a shifted mode according to the type of the device;
receiving a mode shifting signal during the connection of the device; and
shifting from the default mode to the shifted mode in response to a mode shifting signal.

18. The method of claim 17, further comprising backing up one or more tasks to shift into the shifted mode in response to the mode shifting signal, and terminating the one or more tasks.

19. The method of claim 18, further comprising prioritizing tasks, and storing information of the prioritized tasks from a lower-prioritized task to a higher-prioritized task.

20. The method of claim 19, further comprising restoring the one or more backed-up tasks from a higher-prioritized task to a lower-prioritized task using the information of the prioritized tasks, and shifting from the shifted mode to the default mode.
